(19) United States
(12) Patent Application Publication
(10) Pub. No.: US 2007/0237733 A1
(43) Pub. Date: Oct. 11, 2007

(54) Cosmetic Composition of Water-in-Water Emulsion type Based on Surfactants and Cationic Polymers

(76) Inventors: Frederic Simonet, Touquin (FR); Luc Nicolas-Morgantini, Rully (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/585,209

(22) PCT Filed: Dec. 21, 2004
(86) PCT No.: PCT/FR04/03318

§ 371 Date: May 30, 2007

Related U.S. Application Data
(60) Provisional application No. 60/540,329, filed on Feb. 2, 2004.

(30) Foreign Application Priority Data
Jan. 5, 2004 (FR) 0400026

(51) Int. Cl. A61Q 5/12

(52) U.S. Cl. 424/70.12; 424/70.11

(57) ABSTRACT

Cosmetic composition of water-in-water emulsion type based on surfactants and cationic polymers The present invention relates to a cosmetic composition of water-in-water emulsion type comprising, in a cosmetically acceptable aqueous medium: at least one surfactant, at least 2.25% by weight, relative to the total weight of the composition, of at least one water-soluble salt,
at least 0.5% by weight, relative to the total weight of the composition, of at least one cationic polymer with a weight-average molecular mass of greater than 10⁵, in a water-soluble salt(s)/cationic polymer(s) weight ratio of greater than 4.5. The invention also relates to the use of this composition for washing and conditioning keratin materials, and in particular the hair.

The present invention relates to a cosmetic composition of water-in-water emulsion type comprising a particular surfactant(s) /cationic polymer(s) /water-soluble salt(s) combination, to the use of the said composition for washing and conditioning the hair, and to a cosmetic process for treating keratin materials using this composition.

In the cosmetics field, when an anionic surfactant and a cationic polymer are mixed together in aqueous solution, an associative phase separation is generally observed. Specifically, an electrostatic complex is formed with the two cationic and anionic compounds, this complex being insoluble and leading to the formation of a precipitate. A third compound, such as an amphoteric surfactant, an alcohol or a salt, may be added to avoid the formation of the complex and to obtain a clear one-phase system.

Moreover, when two polymers are mixed together in aqueous solution, a segregative phase separation is observed, i.e. two phases are formed, each enriched in one of the two polymers, the water partitioning between the two phases. This separation is due to the thermodynamic incompatibility between the two polymers and is proportionately greater the higher the concentrations or molar masses of the polymers.

Thus, no system exists that allows the production of a liquid dispersed phase, enriched in cationic polymer, in a surfactant medium, especially an anionic surfactant medium.

The Applicant has discovered, surprisingly, that droplets enriched in cationic polymer can be obtained in a surfactant medium by mixing together certain amounts of cationic polymer and of water-soluble salt in a surfactant medium. The addition of the water-soluble salt makes it possible to avoid the formation of insoluble complexes between the cationic polymer and the surfactant(s) of the medium. This type of system will be referred to hereinbelow as a water-in-water emulsion.

The droplets present in this emulsion have a mean size of greater than 0.1 μm and preferably less than 100 μm as measured by optical microscopy.

In addition, this emulsion allows access to a new mode of vectorization of cationic polymers and of cosmetic agents on keratin fibres.

The emulsion according to the invention also has better flow qualities, i.e. it does not flow in blobs, which users appreciate.

One subject of the invention is thus a cosmetic composition of water-in-water emulsion type comprising, in a cosmetically acceptable aqueous medium, at least one surfactant, a suitable amount of at least one water-soluble salt and a suitable amount of at least one cationic polymer with a weight-average molecular mass of greater than 10⁵, in a particular water-soluble salt(s)/cationic polymer(s) weight ratio.

Another subject of the invention is the use of the composition for washing and conditioning keratin materials such as the hair.

A subject of the invention is also a cosmetic process for treating keratin materials using the composition according to the invention.

Other subjects, characteristics, aspects and advantages of the invention will emerge even more clearly on reading the description and the various examples that follow.

According to the invention, the cosmetic composition of water-in-water emulsion type comprises, in a cosmetically acceptable aqueous medium:
at least one surfactant,
at least 2.25% by weight, relative to the total weight of the composition, of at least one water-soluble mineral or organic salt comprising, when it is organic, from 1 to 7 carbon atoms in the anion,
at least 0.5% by weight, relative to the total weight of the composition, of at least one cationic polymer with a weight-average molecular mass of greater than 10⁵,
   in a water-soluble salt(s)/cationic polymer(s) weight ratio of greater than or equal to 4.5, preferably ranging from 4.5 to 19 and better still from 4.5 to 15.

The surfactants that may be used in the composition according to the invention may be anionic, amphoteric, nonionic or cationic.

As anionic surfactants that may be used, alone or as mixtures, in the context of the present invention, mention may be made especially of the salts, in particular the alkali metal salts such as the sodium salts, the ammonium salts, the amine salts, the amino alcohol salts or the alkaline-earth metal salts, for example the magnesium salts, of the following compounds: alkyl sulfates, alkyl ether sulfates, alkylamido ether sulfates, alkylarylpolyether sulfates, monoglyceride sulfates; alkylsulfonates, alkyl phosphates, alkylamidesulfonates, alkylarylsulfonates, α-olefin sulfonates, paraffin sulfonates; alkyl sulfo-succinates, alkyl ether sulfosuccinates, alkylamide sulfosuccinates; alkyl sulfoacetates; acyl sarcosinates; and acylglutamates, the alkyl or acyl groups of all these compounds containing from 6 to 24 carbon atoms and the aryl group preferably denoting a phenyl or benzyl group.

It is also possible to use C₆-C₂₄ alkyl esters of polyglycosidecarboxylic acids such as alkyl glucoside citrates, polyalkyl glycoside tartrates, and polyalkyl-glycoside sulfosuccinates; alkyl sulfosuccinamates, acyl isethionates and N-acyltaurates, the alkyl or acyl group of all these compounds containing from 12 to 20 carbon atoms. Among the anionic surfactants that may also be used, mention may also be made of acyl lactylates in which the acyl group contains from 8 to 20 carbon atoms.

In addition, mention may also be made of alkyl-D-galactosideuronic acids and the salts thereof, and also polyoxyalkylenated (C₆-C₂₄)alkyl ether carboxylic acids, polyoxyalkylenated (C₆-C₂₄) alkyl (C₆-C₂₄) aryl ether carboxylic acids, polyoxyalkylenated (C₆-C₂₄)alkylamido ether carboxylic acids and salts thereof, in particular those containing from 2 to 50 ethylene oxide groups, and mixtures thereof.

Among the anionic surfactants mentioned above, it is preferred according to the invention to use alkyl sulfates, alkyl ether sulfates, for instance sodium lauryl ether sulfate preferably containing 2 or 3 mol of ethylene oxide, alkyl ether carboxylates, the alkyl groups generally containing from 6 to 24 carbon atoms and preferably from 8 to 16 carbon atoms, in the particular form of sodium, magnesium or ammonium salts.

The amphoteric surfactants that are suitable in the present invention may especially be aliphatic secondary or tertiary amine derivatives in which the aliphatic group is a linear or branched chain containing from 8 to 22 carbon atoms and containing at least one water-solubilizing anionic group, for instance a carboxylate, sulfonate, sulfate, phosphate or phosphonate group; mention may also be made of (C₈-C₂₀)alkylbetaines, sulfobetaines, (C₈-C₂₀)alkylamido(C₆-C₈)alkylbetaines or (C₈-C₂₀)alkylamido(C₆-C₈)alkylsulfobetaines, and mixtures thereof.

Among the amine derivatives, mention may be made of the products sold under the name Miranol®, as described in U.S. Pat. Nos. 2,528,378 and 2,781,354 and classified in the CTFA dictionary, 3rd edition, 1982, under the names Amphocarboxyglycinate and Amphocarboxypropionate, having the respective structures (1) and (2):
Rₐ—CONHCH₂CH₂—N⁺(R_{b})(R_{c})(CH₂COO⁻) (1)
in which:

Rₐ represents an alkyl group derived from an acid Rₐ—COOH present in hydrolyzed coconut oil, or a heptyl, nonyl or undecyl group,

R_{b} represents a β-hydroxyethyl group, and

R_{c} represents a carboxymethyl group; and
R_{a′}—CONHCH₂CH₂—N(B)(C) (2)
in which:

B represents —CH₂CH₂OX′,

C represents —(CH₂)_{z}—Y′, with z=1 or 2,

X′ represents a —CH₂CH₂—COOH group or a hydrogen atom,

Y′ represents —COOH or a —CH₂—CHOH—SO₃H group,

Rₐ′ represents an alkyl group of an acid Rₐ′-COOH present in coconut oil or in hydrolyzed linseed oil, an alkyl group, in particular a C₁₇ alkyl group and its iso form, or an unsaturated C₁₇ group.

These compounds are classified in the CTFA dictionary, 5th edition, 1993, under the names disodium cocoamphodiacetate, disodium lauroamphodiacetate, disodium caprylamphodiacetate, disodium capryloamphodiacetate, disodium cocoamphodipropionate, disodium lauroamphodipropionate, disodium caprylamphodipropionate, disodium capryloamphodipropionate, lauroamphodipropionic acid and cocoamphodipropionic acid.

By way of example, mention may be made of the cocoamphodiacetate sold by the company Rhodia under the trade name Miranol® C2M concentrate.

Among the amphoteric surfactants that are preferably used are (C₈-C₂₀)alkylbetaines, (C₈-C₂₀)alkylamido C₆-C₈)alkylbetaines, alkylamphomonoacetates and alkyl-amphodiacetates, and mixtures thereof.

The nonionic surfactants that may be used in the composition according to the invention are compounds that are well known per se (see in particular in this respect the “Handbook of Surfactants” by M. R. Porter, published by Blackie & Son (Glasgow and London), 1991, pp. 116-178). Thus, they may be chosen especially from polyethoxylated, polypropoxylated or polyglycerolated fatty acids, (C₁-C₂₀)alkylphenols, α-diols or alcohols having a fatty chain containing, for example, 8 to 18 carbon atoms, it being possible for the number of ethylene oxide or propylene oxide groups to range in particular from 2 to 50 and for the number of glycerol groups to range in particular from 2 to 30. Mention may also be made of copolymers of ethylene oxide and of propylene oxide, condensates of ethylene oxide and of propylene oxide with fatty alcohols; polyethoxylated fatty amides preferably having from 2 to 30 mol of ethylene oxide, polyglycerolated fatty amides containing on average 1 to 5, and in particular 1.5 to 4, glycerol groups; polyethoxylated fatty amines preferably having 2 to 30 mol of ethylene oxide; ethoxylated fatty acid esters of sorbitan having from 2 to 30 mol of ethylene oxide; fatty acid esters of sucrose, fatty acid esters of polyethylene glycol, (C₆-C₂₄) alkylpolyglycosides, N—(C₆-C₂₄) alkylglucamine derivatives, amine oxides such as (C₁₀-C₁₄)alkylamine oxides or N—(C₁₀-C₁₄)acylaminopropylmorpholine oxides; and mixtures thereof.

Among the abovementioned nonionic surfactants that are preferably used are (C₆-C₂₄)alkylpolyglycosides.

Examples of cationic surfactants that may especially be mentioned include salts of optionally polyoxyalkylenated primary, secondary or tertiary fatty amines; quaternary ammonium salts such as tetraalkylammonium, alkylamidoalkyltrialkylammonium, trialkylbenzylammonium, trialkylhydroxyalkylammonium or alkylpyridinium chlorides or bromides; imidazoline derivatives; or amine oxides of cationic nature.

Preferably, the compositions of the invention contain at least one anionic surfactant optionally combined with one or more amphoteric or nonionic surfactants.

Advantageously, these compositions contain at least one anionic surfactant and at least one amphoteric surfactant.

The surfactants are generally present in a total amount ranging from 0.5% to 50% by weight, preferably from 4% to 50% by weight and even more preferentially from 4% to 20% by weight relative to the total weight of the cosmetic composition.

The water-soluble salts that may be used in the present invention are chosen from water-soluble salts of monovalent or divalent metals, for example of alkali metal or alkaline-earth metals, of ammonium or of amines, and of mineral acids or of carboxylic acids. The organic salts comprise from 1 to 7 carbon atoms in the anion.

Examples of such salts that may especially be mentioned include sodium chloride, potassium chloride, calcium chloride, magnesium chloride, ammonium chloride, monoethanolamine chloride, sodium citrate, ammonium citrate, magnesium sulfate and the sodium salts of phosphoric acid. The salts of monovalent metals are preferably used, and sodium chloride is particularly preferred.

For the purposes of the present invention, the term “water-soluble” means a compound having, at 25° C. and at atmospheric pressure, a solubility in water of greater than or equal to 1% and preferably greater than or equal to 2.5%.

The water-soluble salts, including those present as adjuvants of the starting materials used, are preferably present in an amount ranging from 2.25% to 30% by weight, better still strictly greater than 3% by weight, more preferentially ranging from 3.1% to 30% by weight and even more preferentially from 3.1% to 10% by weight relative to the total weight of the composition. The term “cationic polymer” means any polymer containing cationic groups and/or groups that may be ionized into cationic groups.

The cationic polymers that may be used in accordance with the present invention may be chosen from all those already known per se as improving the cosmetic properties of hair treated with detergent compositions, i.e. especially those described in patent application EP-A-0 337 354 and in French patent applications FR-A-2 270 846, 2 383 660, 2 598 611, 2 470 596 and 2 519 863.

The cationic polymers that are preferred are chosen from those containing units comprising primary, secondary, tertiary and/or quaternary amine groups that either may form part of the main polymer chain or may be borne by a side substituent directly attached thereto.

The cationic polymers used have a weight-average molecular mass of greater than 10⁵ and preferably between 10⁵ and 10⁸.

Among the cationic polymers that may be mentioned more particularly are polymers of the polyamine, polyamino amide and polyquaternary ammonium type. These are known products.

The polymers of the polyamine, polyamino amide and polyquaternary ammonium type that may be used in the composition of the present invention are those described in French patents 2 505 348 and 2 542 997. Among these polymers, mention may be made of:

(1) homopolymers or copolymers derived from acrylic or methacrylic esters or amides containing an amine function, comprising at least one of the units of the following formulae: 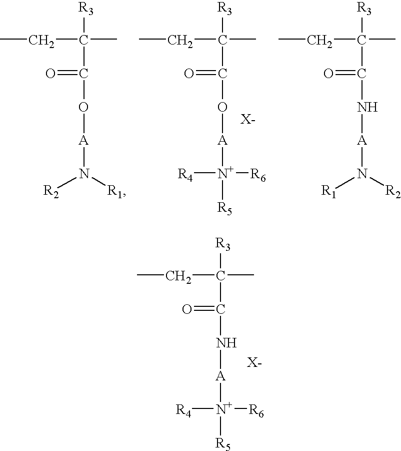
in which:

R₁ and R₂, which may be identical or different, represent a hydrogen atom or an alkyl group containing from 1 to 6 carbon atoms, and preferably a methyl or ethyl group;

R₃, which may be identical or different, denote hydrogen or a CH₃ group;

the symbols A, which may be identical or different, represent a linear or branched alkyl group of 1 to 6 carbon atoms, preferably 2 or 3 carbon atoms, or a hydroxyalkyl group of 1 to 4 carbon atoms;

R₄, R₅ and R₆, which may be identical or different, represent an alkyl group containing from 1 to 18 carbon atoms or a benzyl group and preferably an alkyl group containing from 1 to 6 carbon atoms;

X⁻ denotes an anion derived from a mineral or organic acid, such as a methosulfate anion or a halide such as chloride or bromide.

The copolymers of family (1) can also contain one or more units derived from comonomers which may be chosen from the family of acrylamides, methacrylamides, diacetone acrylamides, acrylamides and methacrylamides substituted on the nitrogen atom with (C₁-C₄) lower alkyl groups, groups derived from acrylic or methacrylic acids or esters thereof, from vinyllactams such as vinylpyrrolidone or vinylcaprolactam, or from vinyl esters.

Thus, among these copolymers of family (1) that may be mentioned are:

copolymers of acrylamide and of dimethylaminoethyl methacrylate quaternized with dimethyl sulfate or with a dimethyl halide,

the copolymers of acrylamide and of methacryl-oyloxyethyltrimethylammonium chloride described, for example, in patent application EP-A-080 976,

copolymers of acrylamide and of methacryl-oyloxyethyltrimethylammonium methosulfate,

quaternized or non-quaternized vinylpyrrolidone/ dialkylaminoalkyl acrylate or methacrylate copolymers. These polymers are described in detail in French patents 2 077 143 and 2 393 573,

dimethylaminoethyl methacrylate/vinylcapro-lactam/vinylpyrrolidone terpolymers,

vinylpyrrolidone/methacrylamidopropyldimethyl-amine copolymers, and

quaternized vinylpyrrolidone/dimethylamino-propylmethacrylamide copolymers.

(2) The cellulose ether derivatives comprising quaternary ammonium groups, which are described in French patent 1 492 597, and in particular the polymers sold under the names “JR” (JR 400, JR 125, JR 30M) or “LR” (LR 400, LR 30M) by the company Union Carbide Corporation. These polymers are also defined in the CTFA dictionary as hydroxyethylcellulose quaternary ammoniums that have reacted with an epoxide substituted with a trimethylammonium group.

(3) Cationic cellulose derivatives such as the copolymers of cellulose or cellulose derivatives grafted with a water-soluble quaternary ammonium monomer, described especially in patent U.S. Pat. No. 4,131,576, such as hydroxyalkylcelluloses, for instance hydroxymethyl-, hydroxyethyl- or hydroxypropyl-celluloses grafted especially with a methacryloyl-ethyltrimethylammonium, methacrylamidopropyltrimethyl-ammonium or dimethyldiallylammonium salt.

The commercial products corresponding to this definition are more particularly the products sold under the names Celquat® L 200 and Celquat® H 100 by the company National Starch.

(4) The cationic polysaccharides described in patents U.S. Pat. Nos. 3,589,578 and 4,031,307, such as guar gums containing trialkylammonium cationic groups. Use is made, for example, of guar gums modified with a salt (e.g. chloride) of 2,3-epoxypropyltrimethylammonium.

Such products are sold especially under the trade names Jaguar® C13S, Jaguar® C15, Jaguar® C17 and Jaguar® C162 by the company Meyhall.

(5) Polymers consisting of piperazinyl units and of divalent alkylene or hydroxyalkylene groups containing straight or branched chains, optionally interrupted with oxygen, sulfur or nitrogen atoms or with aromatic or heterocyclic rings, and also the oxidation and/or quaternization products of these polymers. Such polymers are described, in particular, in French patents 2 162 025 and 2 280 361.

(6) Water-soluble polyamino amides prepared in particular by polycondensation of an acidic compound with a polyamine; these polyamino amides can be crosslinked with an epihalohydrin, a diepoxide, a dianhydride, an unsaturated dianhydride, a bis-unsaturated derivative, a bis-halohydrin, a bis-azetidinium, a bis-haloacyldiamine, a bis-alkyl halide or alternatively with an oligomer resulting from the reaction of a difunctional compound which is reactive with a bis-halohydrin, a bis-azetidinium, a bis-haloacyldiamine, a bis-alkyl halide, an epihalohydrin, a diepoxide or a bis-unsaturated derivative; the crosslinking agent is used in proportions ranging from 0.025 to 0.35 mol per amine group of the polyamino amide; these polyamino amides can be alkylated or, if they contain one or more tertiary amine functions, they can be quaternized. Such polymers are described, in particular, in French patents 2 252 840 and 2 368 508.

(7) Polyamino amide derivatives resulting from the condensation of polyalkylene polyamines with polycarboxylic acids followed by alkylation with difunctional agents. Mention may be made, for example, of adipic acid/dialkylaminohydroxyalkyldialkylene-triamine polymers in which the alkyl group contains from 1 to 4 carbon atoms and preferably denotes a methyl, ethyl or propyl group, and the alkylene group contains from 1 to 4 carbon atoms, and preferably denotes an ethylene group. Such polymers are described in particular in French patent 1 583 363.

Among these derivatives, mention may be made more particularly of the adipic acid/dimethylamino-hydroxypropyl/diethylenetriamine polymers.

(8) Polymers obtained by reaction of a polyalkylene polyamine containing two primary amine groups and at least one secondary amine group with a dicarboxylic acid chosen from diglycolic acid and saturated aliphatic dicarboxylic acids containing from 3 to 8 carbon atoms. The molar ratio between the polyalkylene polyamine and the dicarboxylic acid is between 0.8:1 and 1.4:1; the polyamino amide resulting therefrom is reacted with epichlorohydrin in a molar ratio of epichlorohydrin relative to the secondary amine group of the polyamino amide of between 0.5:1 and 1.8:1. Such polymers are described in particular in U.S. Pat. Nos. 3 227 615 and 2 961 347.

(9) Cyclopolymers of alkyldiallylamine or of dialkyldiallylammonium, such as the homopolymers or copolymers containing, as main constituent of the chain, units corresponding to formula (Va) or (Vb): 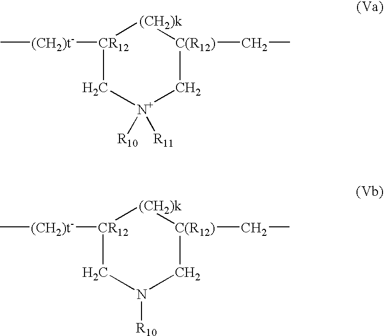
in which k and t are equal to 0 or 1, the sum k+t being equal to 1; R₁₂ denotes a hydrogen atom or a methyl radical; R₁₀ and R₁₁, independently of each other, denote an alkyl group containing from 1 to 6 carbon atoms, a hydroxyalkyl group in which the alkyl group preferably contains from 1 to 5 carbon atoms, a lower (C₁-C₄) amidoalkyl group, or R₁₀ and R₁₁ can denote, together with the nitrogen atom to which they are attached, heterocyclic groups such as piperidyl or morpholinyl; Y⁻ is an anion such as bromide, chloride, acetate, borate, citrate, tartrate, bisulfate, bisulfite, sulfate or phosphate. These polymers are described in particular in French patent 2 080 759 and in its Certificate of Addition 2 190 406.

R₁₀ and R₁₁, independently of each other, preferably denote an alkyl group containing from 1 to 4 carbon atoms.

Among the polymers defined above, mention may be made more particularly of the dimethyldiallylammonium chloride homopolymer sold under the name Merquat® 100 by the company Calgon (and its homologues of low weight-average molecular mass) and copolymers of diallyldimethylammonium chloride and of acrylamide, sold under the name Merquat® 550.

(10) The diquaternary ammonium polymers containing repeating units corresponding to formula (VI): 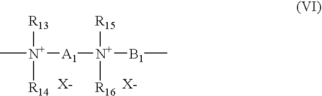
in which:

R₁₃, R₁₄, R₁₅ and R₁₆, which may be identical or different, represent aliphatic, alicyclic or arylaliphatic groups containing from 1 to 20 carbon atoms or lower hydroxyalkylaliphatic groups, or alternatively R₁₃, R₁₄, R₁₅ and R₁₆, together or separately, constitute, with the nitrogen atoms to which they are attached, heterocycles optionally containing a second heteroatom other than nitrogen, or alternatively R₁₃, R₁₄, R₁₅ and R₁₆ represent a linear or branched C₁-₆ alkyl group substituted with a nitrile, ester, acyl or amide group or a group —CO—O—R₁₇-D or —CO—NH-R₁₇-D where R₁₇ is an alkylene group and D is a quaternary ammonium group;

A₁ and B₁ represent polymethylene groups containing from 2 to 20 carbon atoms, which groups may be linear or branched, saturated or unsaturated, and which may contain, linked to or intercalated in the main chain, one or more aromatic rings or one or more oxygen or sulfur atoms or sulfoxide, sulfone, disulfide, amino, alkylamino, hydroxyl, quaternary ammonium, ureido, amide or ester groups, and

X⁻ denotes an anion derived from a mineral or organic acid;

A₁, R₁₃ and R₁₅ can form, with the two nitrogen atoms to which they are attached, a piperazine ring; in addition, if A₁ denotes a linear or branched, saturated or unsaturated alkylene or hydroxyalkylene group, B₁ can also denote a group:
—(CH₂)ₙ—CO-D-OC—(CH₂)ₙ—
in which D denotes:

a) a glycol residue of formula: —O-Z-O—, where Z denotes a linear or branched hydrocarbon-based group or a group corresponding to one of the following formulae:
—(CH₂—CH₂—O)ₓ—CH₂—CH₂—
—[CH₂—CH (CH₃)—O]_{y}—CH₂—CH(CH₃)—
where x and y denote an integer from 1 to 4, representing a defined and unique degree of polymerization or any number from 1 to 4 representing an average degree of polymerization;

b) a bis-secondary diamine residue such as a piperazine derivative;

c) a bis-primary diamine residue of formula —NH—Y—NH—, where Y denotes a linear or branched hydrocarbon-based group, or alternatively the divalent group —CH₂—CH₂—S—S—CH₂—CH₂—;

d) a ureylene group of formula —NH—CO—NH—.

Preferably, X⁻ is an anion such as chloride or bromide.

Polymers of this type are described in particular in French patents 2 320 330, 2 270 846, 2 316 271, 2 336 434 and 2 413 907 and U.S. Pat. Nos. 2,273,780, 2,375,853, 2,388,614, 2,454,547, 3,206,462, 2,261,002, 2,271 378, 3,874,870, 4,001,432, 3,929,990, 3,966,904, 4,005 193, 4,025,617, 4,025,627, 4,025,653, 4,026,945 and 4,027,020.

It is more particularly possible to use polymers that consist of repeating units corresponding to the formula: 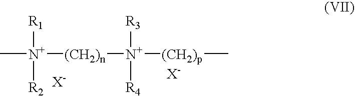
in which R₁, R₂, R₃ and R₄, which may be identical or different, denote an alkyl or hydroxyalkyl group containing from 1 to 4 carbon atoms approximately, n and p are integers ranging from 2 to 20 approximately, and X⁻ is an anion derived from a mineral or organic acid.

(11) Polyquaternary ammonium polymers consisting of units of formula (VIII): 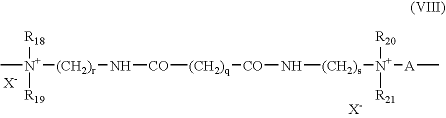
in which:

R₁₈, R₁₉, R₂₀ and R₂₁, which may be identical or different, represent a hydrogen atom or a methyl, ethyl, propyl, β-hydroxyethyl, β-hydroxypropyl or —CH₂CH₂(OCH₂CH₂)ₚOH radical, where p is equal to 0 or to an integer between 1 and 6, with the proviso that R₁₈, R₁₉, R₂₀ and R₂₁ do not simultaneously represent a hydrogen atom,

r and s, which may be identical or different, are integers between 1 and 6,

q is equal to 0 or to an integer between 1 and 34,

X⁻ denotes an anion such as a halide,

A denotes a dihalide radical or preferably represents —CH₂—CH₂—O—CH₂—CH₂—.

Such compounds are described in particular in patent application EP-A-122 324.

(12) Quaternary polymers of vinylpyrrolidone and of vinylimidazole.

(13) Crosslinked methacryloyloxy(C₁-₄)alkyltri-(C₁-₄)alkylammonium salt polymers such as the polymers obtained by homopolymerization of dimethylaminoethyl methacrylate quaternized with methyl chloride, or by copolymerization of acrylamide with dimethylaminoethyl methacrylate quaternized with methyl chloride, the homo- or copolymerization being followed by crosslinking with an olefinically unsaturated compound, in particular methylenebisacrylamide.

Other cationic polymers that may be used in the context of the invention are cationic proteins or cationic protein hydrolysates, polyalkyleneimines, in particular polyethyleneimines, polymers containing vinylpyridine or vinylpyridinium units, condensates of polyamines and of epichlorohydrin, quaternary polyureylenes and chitin derivatives.

Among all the cationic polymers that may be used in the context of the present invention, it is preferred to use cellulose ether derivatives containing quaternary ammonium groups, such as the products sold under the name JR 400 by the company Union Carbide Corporation, cationic cyclopolymers, in particular the dimethyldiallylammonium chloride homopolymers or copolymers sold under the names Merquat® 100, Merquat® 550 and Merquat® S by the company Calgon, guar gums modified with a 2,3-epoxypropyltrimethylammonium salt, and quaternary polymers of vinylpyrrolidone and of vinylimidazole.

The cationic polymers are preferably present in an amount ranging from 0.5% to 10% by weight and better still from 0.5% to 4% by weight relative to the total weight of the composition.

The term “cosmetically acceptable medium” means a medium that is compatible with keratin materials such as the hair and the skin, but which also has a pleasant odor, look and feel.

The cosmetically acceptable aqueous medium consists of water or of a mixture of water and of at least one cosmetically acceptable solvent chosen from C₁-C₄ lower alcohols such as ethanol, isopropanol, tert-butanol or n-butanol; polyols such as glycerol, propylene glycol and polyethylene glycols; and mixtures thereof.

The pH of the compositions according to the invention is generally between 2 and 11 and preferably between 3 and 10.

The composition according to the invention may also comprise one or more standard additives that are well known in the art, such as linear, branched or cyclic, organomodified or non-organomodified, volatile or non-volatile silicones; natural or synthetic thickeners or viscosity regulators; C₁₂-C₃₀ fatty alcohols; waxes such as plant waxes or ceramides; oily fatty esters such as isopropyl myristate or triglycerides; mineral or synthetic oils such as α-olefins; vitamins or provitamins; nacreous agents; pH stabilizers; preserving agents; and dyes.

A person skilled in the art will take care to select the optional additives and the amount thereof such that they do not harm the properties of the compositions of the present invention.

These additives are generally present in the composition according to the invention in an amount ranging from 0 to 20% by weight relative to the total weight of the composition.

The compositions according to the invention may be prepared at room temperature, i.e. at a temperature of about from 20 to 25° C. The cationic polymer solution is poured into the surfactant solution.

The compositions in accordance with the invention may be used for washing and/or conditioning keratin materials, in particular the hair, for example as conditioning shampoos.

Another subject of the invention is a cosmetic process for treating keratin materials, such as the hair, which consists in applying an effective amount of a composition as described above to the said keratin materials, and rinsing it out after an optional leave-in time.

The examples that follow illustrate the present invention. The amounts indicated below are expressed as weight percentages relative to the total weight of the composition.

### EXAMPLES

Compositions 1 to 3 according to the invention were prepared using the ingredients indicated in the table below.

The percentages indicated in the table below are expressed as percentages of active materials.

| | Composition | | |
|---|---|---|---|
| | 1 | 2 | 3 |
| Sodium lauryl ether sulfate (2.2 | 5% | 12.5% | 4.3% |
| mol of ethylene oxide) | | | |
| Laurylbetaine | — | 2.5% | — |
| Cocoylamidopropylbetaine | 10% | — | 8.6% |
| Poly(dimethyldiallylammonium | 1% | — | 0.4% |
| chloride) ⁽¹⁾ | | | |
| MW = 4 × 10⁵ | | | |
| Poly(dimethyldiallylammonium | — | 0.5% | — |
| chloride/acrylamide) ⁽²⁾ | | | |
| MW = 5 × 10⁶ | | | |
| Cationic-modified guar ⁽³⁾ | — | — | 0.3% |
| MW = 1.2 × 10⁶ | | | |
| NaCl | 5.7% | 6.7% | 3.3% |
| Water qs | 100% | 100% | 100% |
| pH (adjusted with concentrated HCl) | 7 | 7 | 5.1 |

⁽¹⁾ sold under the trade name Merquat ® 100 by the company Nalco.
⁽²⁾ sold under the trade name Merquat ® 550 by the company Nalco.
⁽³⁾ sold under the trade name Jaguar ® C13S by the company Rhodia Chimie.

After mixing together the ingredients, dispersions of droplets about 10 μm in size, containing the cationic polymer(s), are formed in the surfactant matrix.

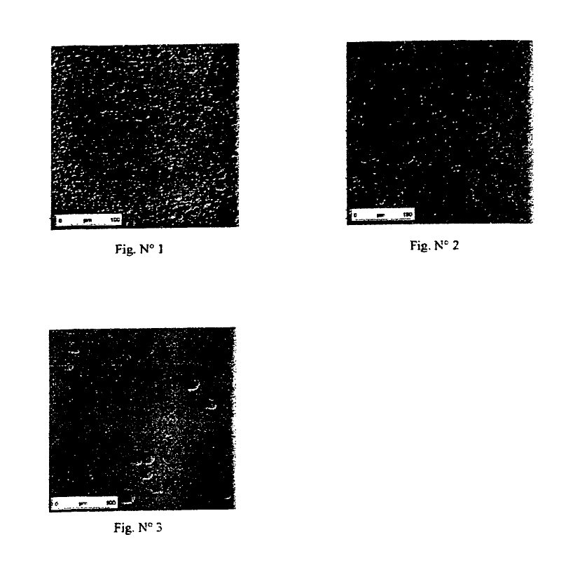

Photographs taken using a Zeiss Axioplan 2 optical microscope, at a magnification of 20×, were taken for the three dispersions (see FIG. 1 to 3).

FIG. 1 corresponds to the photograph of the

dispersion of Example 1,

FIG. 2 corresponds to the photograph of the dispersion of Example 2, and

FIG. 3 corresponds to the photograph of the dispersion of Example 3.

1. A cosmetic composition of water-in-water emulsion type comprising, in a cosmetically acceptable aqueous medium:
at least one surfactant,
at least 2.25% by weight, relative to the total weight of the composition, of at least one water-soluble mineral or organic salt comprising, when it is organic, from 1 to 7 carbon atoms in the anion,
at least 0.5% by weight, relative to the total weight of the composition, of at least one cationic polymer with a weight-average molecular mass of greater than 10⁵,
in a water-soluble salt(s)/cationic polymer(s) weight ratio of greater than or equal to 4.5.

2. The cosmetic composition as claimed in claim 1, characterized in that the water-soluble salts)/cationic polymer(s) weight ratio is between 4.5 and 19 and preferably between 4.5 and 15.

3. The cosmetic composition as claimed in claim 1 or 2, characterized in that the surfactant is anionic, amphoteric, nonionic or cationic.

4. The cosmetic composition as claimed claim 3, characterized in that it comprises at least one anionic surfactant optionally combined with one or more amphoteric or nonionic surfactants.

5. The cosmetic composition as claimed in claim 4, characterized in that it comprises at least one anionic surfactant and at least one amphoteric surfactant.

6. The cosmetic composition as claimed in one of claims 3 to 5, characterized in that the anionic surfactant is chosen from the alkali metal salts, ammonium salts, amine salts, amino alcohol salts or alkaline-earth metal salts of the following compounds: alkyl sulfates, alkyl ether sulfates, alkylamido ether sulfates, alkylarylpolyether sulfates, monoglyceride sulfates; alkyl sulfonates, alkyl phosphates, alkylamide sulfonates, alkylaryl sulfonates, α-olefin sulfonates, paraffin sulfonates; alkyl sulfosuccinates, alkyl ether sulfosuccinates, alkylamide sulfo-succinates; alkyl sulfoacetates; acyl sarcosinates; and acyl glutamates, the alkyl or acyl groups of all these compounds containing from 6 to 24 carbon atoms and the aryl group preferably denoting a phenyl or benzyl group; C₆-C₂₄ alkyl esters of polyglycosidecarboxylic acids; alkyl sulfosuccinamates, acyl isethionates and N-acyltaurates, the alkyl or acyl group of all these compounds containing from 12 to 20 carbon atoms.

7. The cosmetic composition as claimed in claim 6, characterized in that the anionic surfactant is chosen from alkyl sulfates, alkyl ether sulfates, preferably containing 2 or 3 mol of ethylene oxide, and alkyl ether carboxylates, the alkyl groups containing from 6 to 24 carbon atoms, in the form of sodium, magnesium or ammonium salts.

8. The cosmetic composition as claimed any one of claims 3 to 5, characterized in that the amphoteric surfactant is chosen from (C₈-C₂₀)alkylbetaines, (C₈-C₂₀)alkylamido(C₆-C₈)alkylbetaines, alkylamphomono-acetates and alkylamphodiacetates.

9. The cosmetic composition as claimed in any one of the preceding claims, characterized in that it comprises the surfactant(s) in an amount ranging from 0.5% to 50% by weight and preferably from 4% to 50% by weight relative to the total weight of the composition.

10. The cosmetic composition as claimed in any one of the preceding claims, characterized in that the water-soluble salt is chosen from water-soluble salts of monovalent or divalent metals, or of ammonium or of amine, and of mineral acids or of organic carboxylic acids.

11. The cosmetic composition as claimed in claim 10, characterized in that the water-soluble salt is chosen from sodium chloride, potassium chloride, calcium chloride, magnesium chloride, ammonium chloride, monoethanolamine chloride, sodium citrate, ammonium citrate, magnesium sulfate and the sodium salts of phosphoric acid.

12. The cosmetic composition as claimed in any one of the preceding claims, characterized in that it comprises the water-soluble salt(s) in an amount ranging from 2.25% to 30% by weight relative to the total weight of the composition.

13. The cosmetic composition as claimed in any one of the preceding claims, characterized in that the weight-average molecular mass of the cationic polymer is between 10⁵ and 10⁸.

14. The composition as claimed in any one of the preceding claims, characterized in that the cationic polymer is chosen from cellulose ether derivatives comprising quaternary ammonium groups, cationic cyclopolymers, guar gums modified with a 2,3-epoxypropyltrimethylammonium salt and quaternary polymers of vinylpyrrolidone and of vinylimidazole.

15. The composition as claimed in any one of the preceding claims, characterized in that it comprises the cationic polymer(s) in an amount ranging from 0.5% to 10% by weight relative to the total weight of the composition.

16. The composition as claimed in any one of the preceding claims, characterized in that the cosmetically acceptable aqueous medium consists of water or of a mixture of water and of at least one organic solvent.

17. The composition as claimed in any one of the preceding claims, characterized in that it also comprises at least one additive chosen from linear, branched or cyclic, organomodified or non-organomodified, volatile or non-volatile silicones; natural or synthetic thickeners or viscosity regulators; C₁₂-C₃₀ fatty alcohols; waxes; oily fatty esters; mineral or synthetic oils; vitamins or provitamins; nacreous agents; pH stabilizers; preserving agents; and dyes.

18. The use of the composition as claimed in any one of the claims for washing and/or conditioning keratin materials.

19. A cosmetic process for treating keratin materials, which consists in applying an effective amount of a composition as claimed in any one of claims 1 to 17 to the said materials, and rinsing it out after an optional leave-in time.
